(19) United States
(12) Patent Application Publication
(10) Pub. No.: US 2002/0198970 A1
(43) Pub. Date: Dec. 26, 2002

(54) Programmable controller system

(76) Inventor: Shunji Kuwa, Kyoto (JP)

Correspondence Address: BEYER WEAVER & THOMAS LLP, P.O. BOX 778, BERKELEY, CA, 94704-0778, US

(21) Appl. No.: 10/133,981

(22) Filed: Apr. 25, 2002

(30) Foreign Application Priority Data
Apr. 27, 2001 (JP) 2001-133454

(51) Int. Cl. G06F 15/177

(52) U.S. Cl. 709/220; 709/253

(57) ABSTRACT

A programmable controller system includes at least one programmable controller and one or more other devices with which it can exchange data through a network or a bus. The programmable controller stores one or more program blocks and executes them selectively and individually by switching them between active and stopped conditions. At least one of the other devices is adapted to issue a command to have a specified operation carried out on a specified one of the program blocks. Upon receiving this command, the programmable controller carries out the specified operation on the specified programmable block and returns the result of the operation back to the device which issued the command. Such other devices may be themselves a programmable controller, a support tool or a host computer. The command may be to add or delete a specified problem block.

### BACKGROUND OF THE INVENTION

This invention relates to a programmable controller system including a programmable controller for executing programs in units of blocks and other devices such as controllers, support tools and a host computer connected together through a common bus or a network. In particular, this invention relates to such a programmable controller system with which the trouble of changing programs can be minimized when the device structure is changed.

There has been a remarkable progress in the data transmission capability including the speed of communication regarding programmable controllers for controlling equipment and devices due to the recent development in the network technology. Since programmable controllers are becoming less costly and less bulky, it is becoming practical to construct a system with a plurality of programmable controllers connected together through communication lines instead of using a system consisting of a single high-speed programmable controller with a large capacity both from the point of view of the cost and the required space.

The merits of distributing a plurality of programmable controllers of a control system by using a network include the following:

(1) Since the means for structuring a system become more flexible from the points of view of hardware structure and distribution, equipment and devices can be reassembled more easily.

(2) Since operations are distributed among a plurality of programmable controllers, the level of capability required of individual programmable controllers becomes limited and it becomes feasible to make use of inexpensive programmable controllers.

(3) Even if there is an error in the operation, only a portion of the system will be affected because the system includes a plurality of programmable controllers, and hence the reliability of the system as a whole improves.

Since it is becoming feasible to structure a system with a plurality of programmable controllers for the purpose of distributing loads and optimizing performance, this trend to distribute a control system is expected to continue and increase. At the same time, as the cost of semiconductor memories becomes lower and high-performance microcomputer chips become available, the number of input/output points controllable by a single programmable controller is overwhelmingly increasing. The program capacity of programmable controllers is also increasing at the same rate.

The performance level of machines and production equipment themselves is also improving by incorporating programmable controllers and this accelerates the increase in the program capacity.

In the presence of such trends, programmable controllers are beginning to be provided with the function of producing partitioned and hierarchical programs such that large high-quality programs can be produced effectively and also for the purpose of reuse and maintenance supervision. In addition, support tools are also being developed for downloading and uploading program data divided into blocks individually to a programmable controller. Users can make use of such functions to assign programs divided into blocks to individual devices controlled by a single programmable controller to improve the productivity in designing a program by carrying out the designing of individual devices or functions sequentially or by a plurality of users. Thus, even where a single programmable controller is controlling a plurality of objects of control, the program is divided into blocks for each of the objects.

Distribution of a system by means of a network and partitioning of a program may be combined to make the distribution even more flexible such that distribution may now be made not in units of programmable controllers but in units of program blocks spanning the network.

Exchanges between individual programs on distributed programmable controllers are carried out by way of data exchange through a network. Currently, there are two formats for this. One is the so-called message service format carried out through a command by which a request is made to another party and a response which is an answer from this other party. The other is the so-called common memory format according to which each programmable controller is provided with a common memory such that it is as if a plurality of programmable controllers are sharing a common memory area on a plurality of programmable controllers and data are exchanged between the programmable controllers such that these common memories will store the common data. The basic format is to determine a data specification to serve as an interface between programs spanning programmable controllers and to exchange it in the program.

If programmable controllers are distributed, the application program is necessarily distributed. Thus, compared to the conventional system structure using only one programmable controller, there are some problems to be considered.

Firstly, programming becomes complicated because the operation which used to be programmed as a single program must be physically divided into a plurality of programs and the interface between programs carries out only single exchanges of data.

If programmable controllers are physically separated, it becomes easier for a plurality of programmers to work together, each working on the programming of a different programmable controller. On the other hand, a change in the programming logic or address assignment may not be easily communicated to all of the programmers. As a result, a conflict may result among the programs. If exchanges are made by using a data storage area where there is the interface between programs of a plurality of programmable controllers, the changes are relatively frequent. This is one of major causes of problems due to conflict among programs.

When an operation is carried out within one programmable controller but by using data on the conditions of devices connected to other programmable controllers or internally generated data, a simple exchange of data must be repeated many times to bring in external data into one's own programmable controller if the message service format is used. Thus, the network becomes overworked and it may become difficult to retrieve data which vary frequently, depending on the response characteristics of the communication. If the common memory format is used to improve the data exchange frequency, communication process will be carried out even when there is no need for a data exchange and a large common memory may be required if there are many data to be exchanged, adversely affecting the system cost.

Secondly, even if a programming technique is used such that processing is carried out by a programmable controller having I/O and data and only the results are retrieved by one's own programmable controller, the boundary between one logic part and another logic becomes complicated when the device structure is changed. As a result, the workload increases significantly in rewriting and transferring programs when the device structure is changed.

### SUMMARY OF THE INVENTION

It is therefore an object of this invention in view of the above to provide a programmable controller system, programmable controllers and support tools with which a structural method of programming can be used even when programs are distributed among a plurality of programmable controllers and the data exchange means through a network is simplified and made indirect such that the trouble of rewriting programs can be minimized when the device structure is changed. Other objects and effects of the present invention will become clear to a person skilled in the art after studying the disclosure that follows.

A programmable controller system embodying this invention, with which the above and other objects can be accomplished, may be characterized as comprising at least one programmable controller embodying this invention storing one or more program blocks and being adapted to execute these program blocks selectively and individually switching them between an active condition and a stopped condition and a device adapted to exchange data with the programmable controller through communication means such as a network or a bus. The device may be another programmable controller, a support tool or a host computer, including command-issuing means for issuing a command to carry out a specified operation on a specified program block. The programmable controller includes means for receiving such a command issued from the device through the communication means and carrying out an operation according to the received command. With a system thus structured, each of the program blocks stored in the programmable controller can be properly executed not only internally but also by way of a command from outside.

### BRIEF DESCRIPTION OF THE DRAWINGS

FIGS. 1A and 1B are structural diagrams of programmable controller systems embodying this invention.

FIG. 2 is a block diagram for showing the hardware structure of a programmable controller.

FIG. 3 is a block diagram for showing the hardware structure of a support tool.

FIG. 4 is a flowchart of a system program incorporated in the programmable controller.

FIG. 5 is a flowchart of a program operation.

FIG. 6 is a flowchart of network processing.

FIGS. 7 and 8 are a flowchart of processing “Program block starting and result obtaining command”.

FIG. 9 is a flowchart of the processing of “Program block starting command”.

FIG. 10 is a flowchart of the processing of “Program block execution result obtaining command”

FIG. 11 is a flowchart of the processing of “Program block writing command”.

FIG. 12 is a flowchart of the processing of “Program block deleting command”.

FIGS. 13 and 14 are a detailed flowchart of processing of “Program block starting command”.

FIGS. 15 and 16 are a flowchart of a system program for realizing a function of a support tool.

FIGS. 17 and 18 are a flowchart of another system program for realizing a function of a support tool.

FIGS. 19 and 20 are a flowchart of still another system program for realizing a function of a support tool.

FIGS. 21A and 21B show block structures of an application program in a programmable controller.

FIG. 22 shows the structure of a program block.

FIG. 23 shows an example of program block data.

FIG. 24 shows an example of display of the program block data of FIG. 23.

FIGS. 25 and 26 show the content of application program data before and after an addition of a program block.

FIG. 27 shows an example of “Program block status data”.

FIG. 28 shows the content of “Network address data for controllers”.

FIG. 29 shows an example of “Requested network processing data”.

FIG. 30 shows a portion of a program block of a programmable controller.

FIGS. 31-44 are examples of displays made on the display screen.

### DETAILED DESCRIPTION OF THE INVENTION

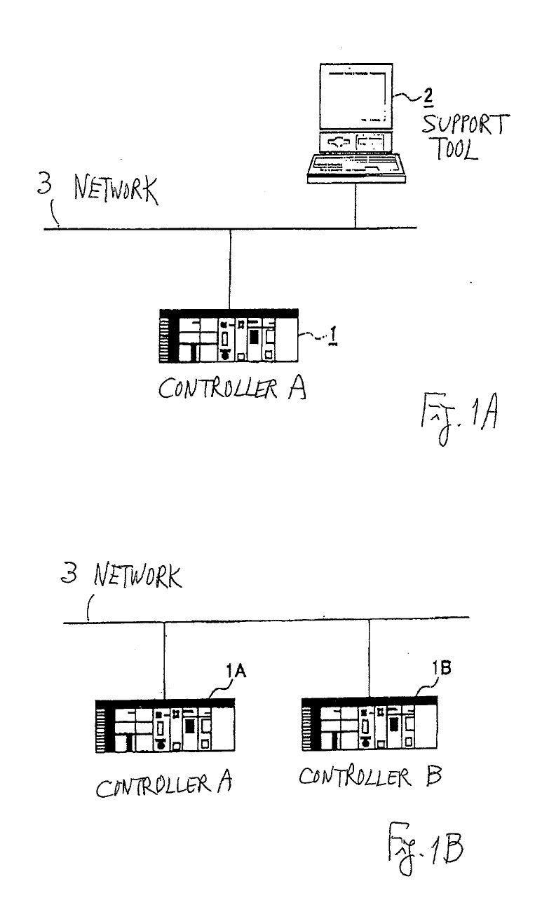

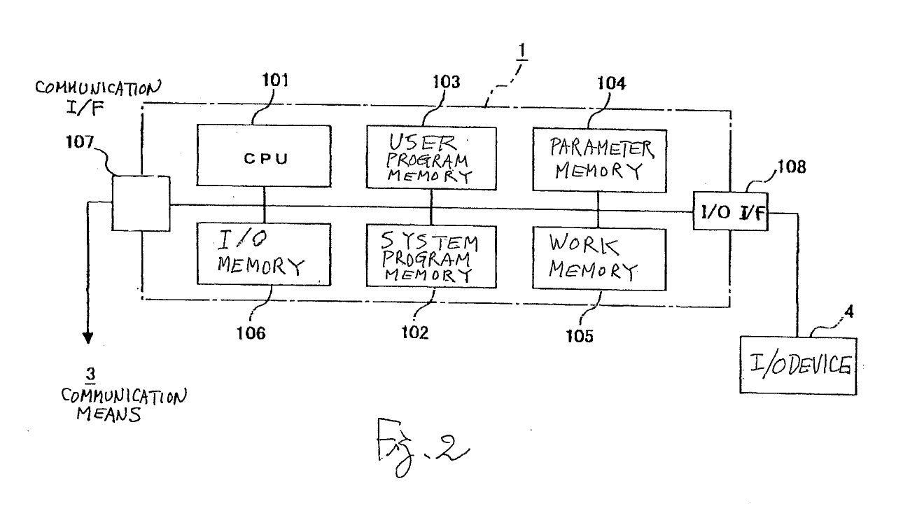

The invention is described next by way of examples. FIG. 1A and 1B show two system structures according to this invention of a programmable controller system (hereinafter also written as “PLC system”). The system structure shown in FIG. 1A is characterized as comprising at least one programmable controller (hereinafter also written as “PLC”) 1, a support tool 2 supporting such PLCs and a network 3 serving as communication means connecting these PLCs 1 and the support tool 2. The system structure shown in FIG. 1B is characterized as comprising at least one PLC (two PLCs 1A and 1B being shown) and a network 3 serving as communication means connecting these PLCs 1A and 1B. The network 3 employs a specified protocol for carrying out serial communication.

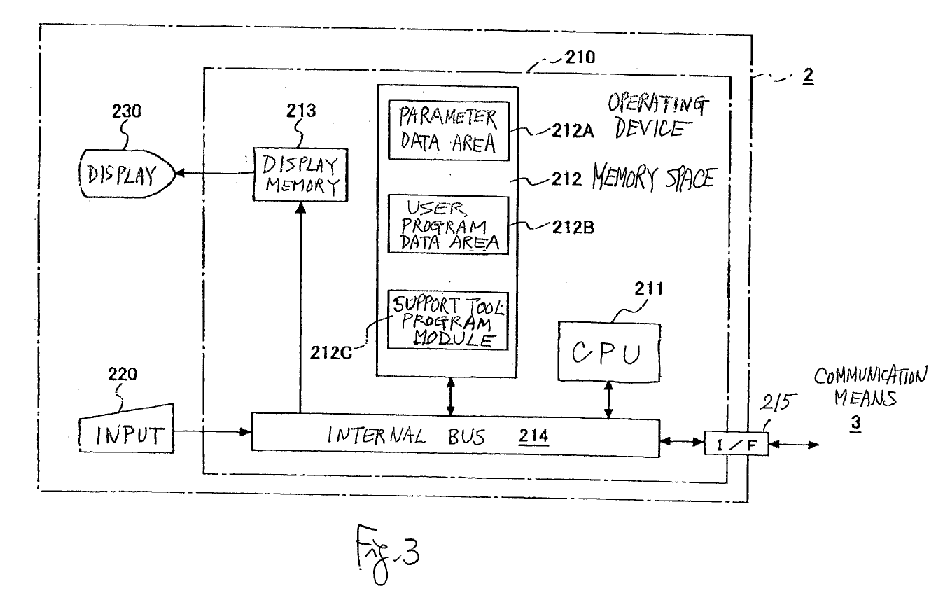

FIG. 2 shows an example of PLC 1 having a system structure of the building block type provided with its own hardware, including a CPU 101, a system program memory 102, a user program memory 103, a parameter memory 104, a work memory 105, an I/O memory 106 , a communication interface 107 and an I/O interface 108 connected by a system bus on a mother board. Numeral 4 indicates an input/output unit for the PLC system. The CPU 101 comprises a microprocessor and dedicated peripheral hardware and serves to carry out some basic functions as a programmable controller by following system programs stored in the system program memory 102. Examples of the basic functions include the so-called I/O refresh process, execution of user programs and many kinds of peripheral service processes. The I/O refresh process is for replacing the content of corresponding input data of the I/O memory 106 with input data taken in from outside through the I/O interface 108 and the input/output device 4 and transmitting output data from the I/O memory 106 to a corresponding external output terminal through the I/O interface 108 and the input/output device 4. In the execution of a user program, command words for the user programs are retrieved sequentially and the contents of input/output data needed for the operation are obtained by referencing the I/O memory 106 and the specified command is carried out. The contents of the output data in the I/O memory 106, the count number and the timer reading are replaced with the results of the execution. In the peripheral service process, communication data are exchanged with the support tool 2 and other PLCs through the communication interface 107 and the communication means (network) 3 and exchanging data with a remote I/O (not shown) or a host personal computer.

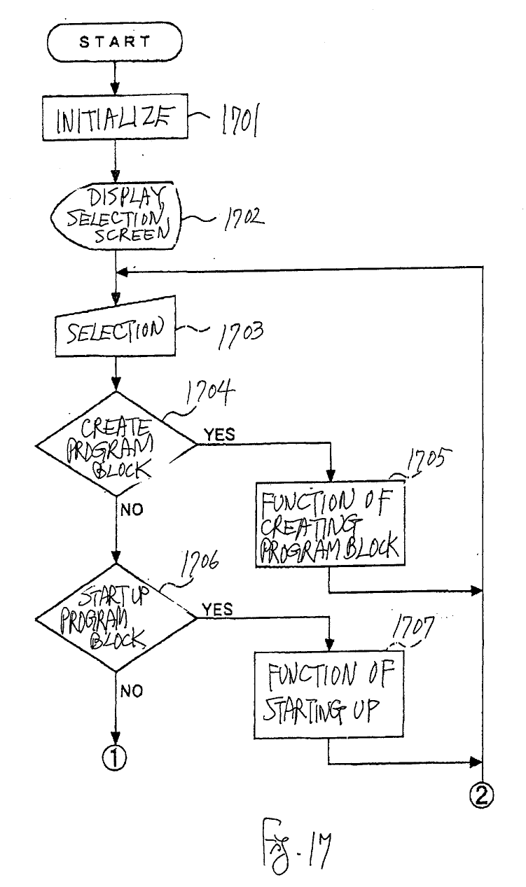

The system program memory 102, comprising a ROM, stores system programs corresponding to the functions to be carried out by the CPU 101. The user program memory 103 stores user programs (or application programs) created by a machine vendor or created and/or corrected by the user in units of program blocks as shown, for example, in FIG. 21. Hundreds and thousands of program blocks may be stored. A flash memory or a battery-backed RAM may be used as the user program memory.

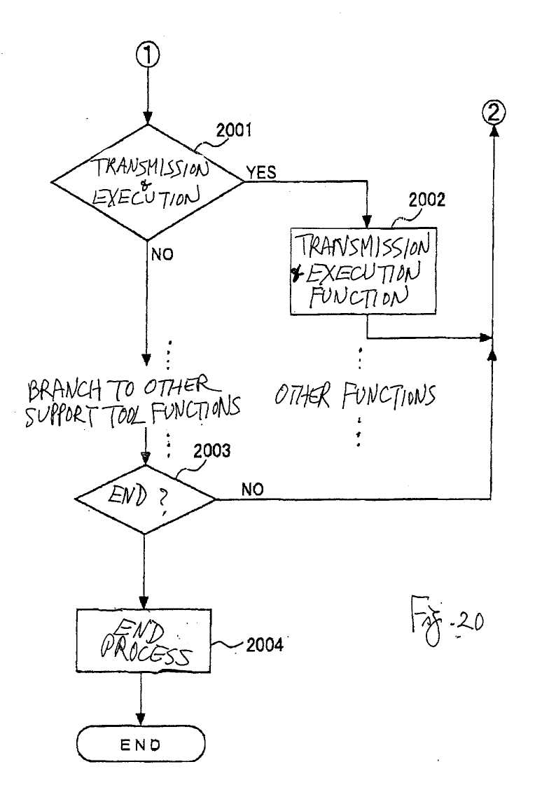

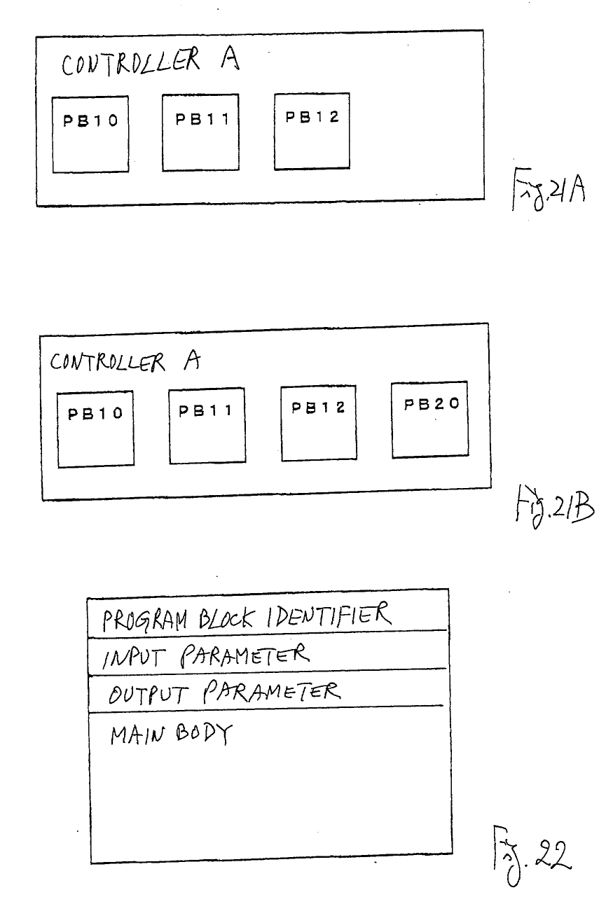

Examples of application program data are shown in FIGS. 25 and 26. In these examples, application program data are formed by storing program blocks PB after a data area identifier at the beginning. The data area identifier indicates the structure of application program data and the stored position of each program block. A list of program blocks which are started at each cycle is also stored here. Thus, it is possible to carry out, read out or write in a specified program block selectively by referencing the data area identifier at the beginning. The data in a program block store the command words to be executed at the time of operating the program in the sequence of their execution. The size of a data area changes, depending on the number of program blocks.

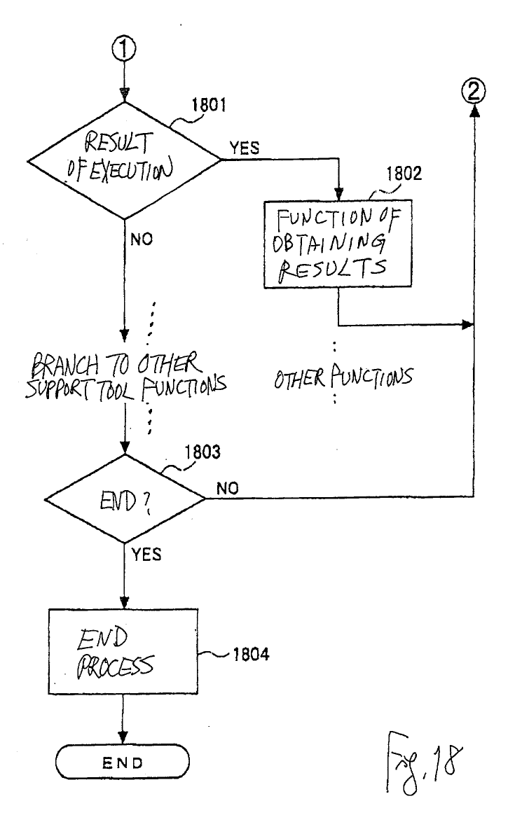

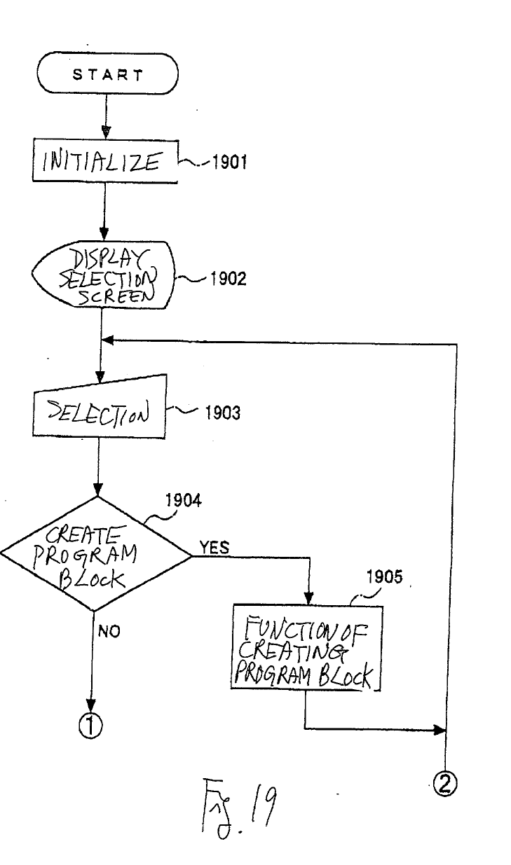

FIG. 22 shows the structure of a program block, including “Program block identifier”, “Input parameter”, “Output parameter” and “Main part”. “Program block identifier” is the ID number of the program block. A unique number within the programmable controller is assigned as the program block ID. “Input parameter” means a parameter for the execution of the main part of the program block and includes input data. “Output parameter” means a parameter representing the result of execution of the program block main part, including a flag and output data. “Main part” comprises an array of program codes executed when the program block is started up such as a ladder program. FIG. 23 shows a portion of FIG. 25 related to PB 10 more in detail. As explained above, data on the program block are stored. As shown, “PB 10” is stored as program block identifier, “DM0000” as input parameter, and “FLG0010” which is a completion-indicating flag and “DM0001” which represents output data as output parameter. FIG. 24 is an example of display for PB10 made on the support tool 2. A1 indicates a display area for program block identifier information, A2 indicates a display area for input parameter, A3 indicates a display area for output parameter and A4 indicates a display area for the main part of the program block where a ladder program is displayed in ladder language.

A program created with specified command words is stored in a program block. When the program block is executed, these command words are sequentially read out and operations are carried out according to the command code. Each command may include a logical operation or an arithmetic operation. In addition, according to this example, the following new commands shown in Table 1 are provided.

TABLE 1

| Operation Code | RCALLPB |
|---|---|
| Operand 1 | Programmable controller identifier code |
| Operand 2 | Program block ID |
| Operand 3 | Execution parameter |
| Operand 4 | Storage address for execution result |

“Operation Code” serves as an identifier indicating that this is a command to start the program block. “Operand 1” is an identifier for the programmable controller storing the program block to be started up. “Operand 2” is an identifier for program block to be started up. “Operand 3” indicates parameter data necessary for the execution of the program block to be started up. “Operand 4” is the memory address of one's own programmable controller for storing the result of execution of the program block to be started up.

When a command is given, the execution parameter specified in “Operand 3” is given to the program block specified by “Operand 1” and “Operand 2”. The result of its execution is received by the program block and stored at the memory address specified by “Operand 4”.

There may be more than one of “Operand 3” and “Operand 4”, depending on the specification of the program block. “Operand 1” may be omitted if the identifier for the program block is unique among all programmable controls of the system.

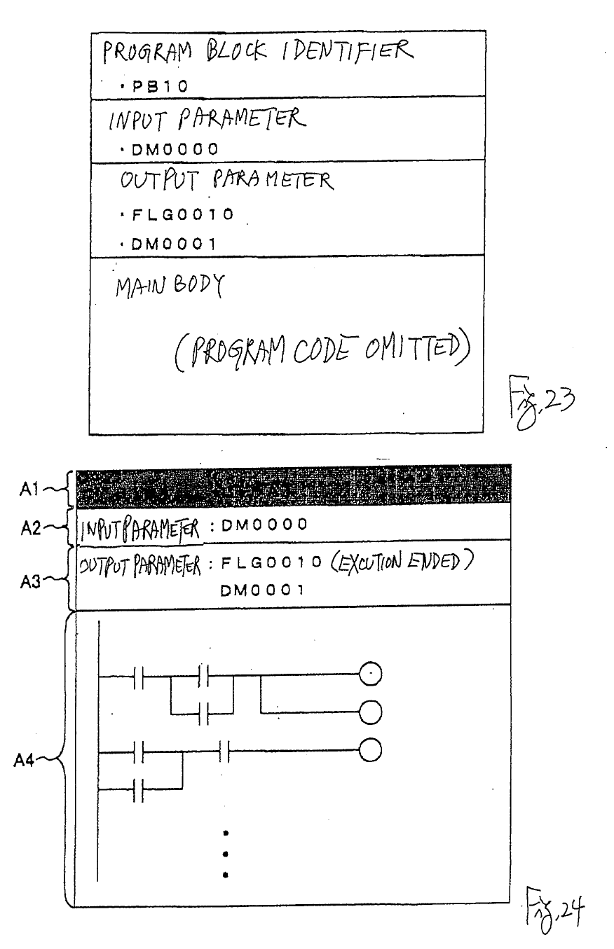

With reference again to FIG. 2, the parameter memory 104 serves to store different kinds of parameters for various operations. “Network Address Data for Controllers” is stored in this parameter memory 104 in connection with the present invention as shown in FIG. 28. This is for recording the addresses of the programmable controllers on the network connected through the network. “Controller ID” and “Network Address” are stored in pairs, where “Controller ID” means the identifier of the programmable controller connected to the network and “Network Address” means the address of the programmable controller on the network.

The work memory 105 usually comprises a RAM and serves to temporarily store data when various calculations and operations are performed. “Program block status data” and “Requested Network Processing Data” are stored in the work memory 105. FIG. 27 shows an example of “Program block status data”. According to this example, the ID (identifier) of each program block, its current status (“Start” or “Stop”) and a “wait completion” flag (“ON” or “OFF”) are stored as a group. “Program block status data” are created at the beginning of the program operation processing with some or all of the program blocks recorded as “Start”. During the operation of the program, the operation of each program block is started or stopped according to the content of this area. The entry (or the status) can be changed, for example, by way of a “program block start command” or a “program block stop command” which are usable in the user program. The operating condition of each program block whether it is started or stopped can be understood by referencing “Program block status data”.

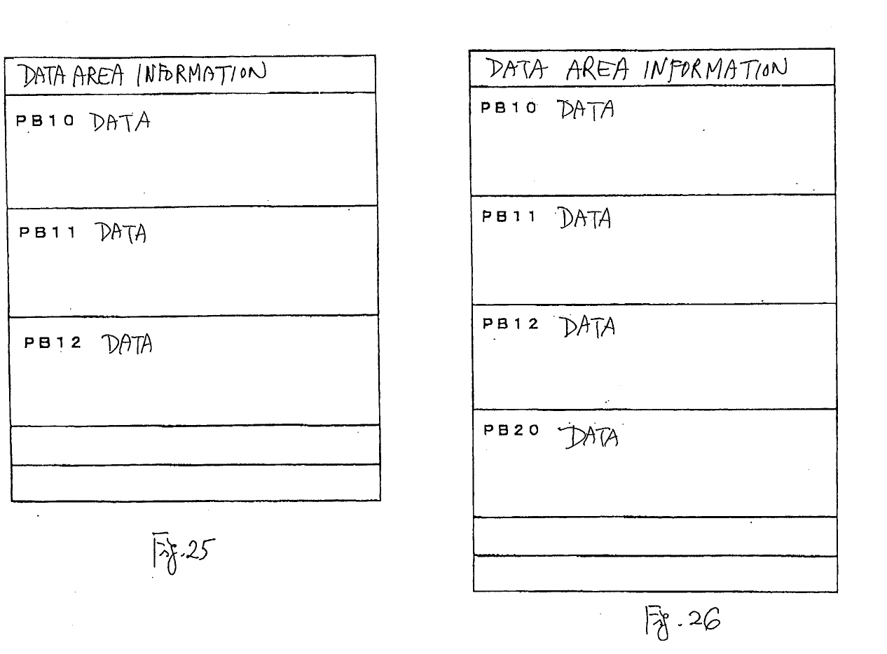

FIG. 29 shows an example of “Requested Network Processing Data”. One of this for command transmission and another for command/response reception are provided to each of controllers. These are data used by the programmable controllers for requesting the issue of a command for network processing. “Addressee Address”, “Command” and “Parameter” are stored as a group. Although the data structure is the same, “Addressee Address” means different things for command transmission and command/response reception. For command transmission, it means the network address where the command is issued. For command/response reception, it means the network address where transmission is made. “Parameter” means parameter corresponding to the command code. The content of request is recorded in the data storage area on the work memory 105. When an entry is made into this area, a search for an empty space is made from the beginning and the new entry is made after the end of the content already requested. Network processing proceeds sequentially from the top of the area. When the issuing of command is completed from a transmission area or when the reception of response or the processing of a command is completed on the command/response reception area, the content of the request is erased and the remaining contents are moved by one step towards the top.

With reference again to FIG. 2, the I/O memory 106 is provided with an input data area, an output data area and a data area for counters and timers. Their contents are referenced and rewritten if necessary when the user program is executed. The communication interface 107 and the I/O interface 108 are for carrying out processes when the communication means 3 and the input/output device 4 are connected. It is through this communication interface 107 that communication becomes possible by “Message Service” to be explained below with the support tool 2, other programmable controllers or a host personal computer.

The input/output device 4 is provided with input terminals through which signals from external sensors and switches are taken in and output terminals through which signals are outputted to drive external relays, motors and actuators. The signals taken in through these input terminals are written in as input data on the I/O memory 106. The signals transmitted out through the output terminals are read out from the I/O memory 106 as output data.

The support tool 2 may be a personal computer with support tool software installed. FIG. 1A shows an example wherein the image display device of a personal computer serving as the program display device of a support tool and the keyboard and the mouse of the personal computer serving as the input device of the support tool. The memory of the personal computer is serving as the memory of the support tool for storing user programs. Support tool software usually includes functions of supporting creation and edition of user programs, transporting created and edited user programs to the PLC to rewrite the user program memory of the PLC entirely or in units of program blocks, reading out a user program from the user program memory of the PLC either as a whole or in units of program blocks to store it on a memory and displaying it on the display screen of the support tool.

As shown in FIG. 3 more in detail, the support tool 2 includes an operating device 210 having a central processing unit (CPU) 211, an input device 220 and a display device 230. The CPU 211 corresponds to that of the personal computer which forms the support tool and serves to control the operations of the support tool 2 as a whole. Memory space 212 includes a parameter data area 212A, a user program data area 212B and a support tool program module 212C. Many kinds of parameters such as “Requested Network Processing Data”, described above with reference to FIG. 29, are stored in the parameter data area 212A. Data such as “Application Program Data Table” to be transmitted to or transmitted from the programmable controller are stored in the user program data area 212B. Programs to be executed by the CPU 211 for carrying out the various functions of the support tool 2 are stored in the support tool program module 212C.

Numeral 213 indicates a display memory for storing data to be outputted to the display device 230. Data are stored on the display memory 213 by the operation of the CPU 211. Numeral 214 indicates an internal bus which functions as an interface for the CPU 211 to access the memory space 212, the input device 220 and the display memory 213. Numeral 215 indicates a communication interface for communicating with the programmable controller.

The input device 220 is for receiving a request from the user through an interface (inclusive of GUI). The keyboard of a personal computer or different kinds of pointers may serve as the input device 220. The display device 230 is for displaying data on the display memory 213 through an interface. The CRT of the personal computer or an LCD may serve as the display device 230.

In this example, as explained above, data are exchanged on the network between PLCs of this PLC system by means of “Message Service” which is used to issue various requests. “Message Service” is used also for exchanging data between the support tool and the programmable control. Messages used by “Message Service” are formed by adding the network address of the addressee to the corresponding command. The addressee is identified by this network address.

Examples of message service command used on the network in this example will be explained next.

(1) “Program Block Starting and Result Obtaining Command”

Parameters of transmitted command are the program block ID of the addressee programmable controller and executed parameter data. The response will include the normal termination code and the execution result data. If the execution did not end normally, an error code is outputted.

(2) “Program Block Starting Command”

Parameters of transmitted command are the program block ID of the addressee controller and executed parameter data. The response will include the normal termination code. If the execution did not end normally, an error code is outputted.

(3) “Program Block Execution Result Obtaining Command”

The program block ID of the addressee controller is the parameter of transmitted command. The response will include the normal termination code and execution result data, or an error code (or unfinished execution).

(4) “Program Block Writing Command”

Parameters of transmitted command are the program block ID and the program block data. The response will be the normal termination code, or an error code if the execution did not end normally for whatever reason.

(5) “Program Block Deleting Command”

The program block ID is the parameter of transmitted command. The response will be the normal termination code, or an error code if the execution did not end normally for whatever reason.

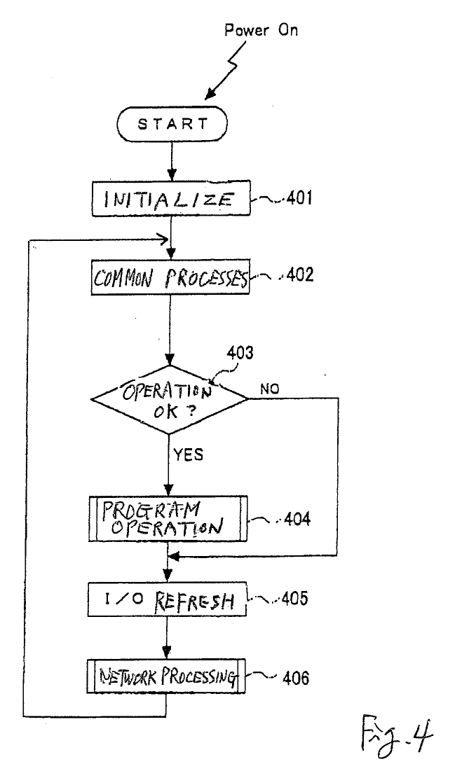

Next, the content of a system program for the programmable controller 1 and the support tool 2 as described above will be explained with reference to the flowchart of FIG. 4. As power is switched on to start the processing, an initialization process is carried out on various flags and registers (Step 401). Thereafter, a flag (not shown) indicating the status of operation of the program is repeatedly referenced until the flag indicates that the program is operable (YES in Step 403). In the meantime (NO in Step 403), various common processes (Step 402), the I/O refresh (Step 405) and network processing (or peripheral service processing) (Step 406) are repeated. When the flag finally shows that the program is operable (YES in Step 403), the program operation is also carried out (Step 404) in addition to the common processes (Step 402), the I/O refresh (Step 405 ) and the network processing (Step 406).

In the above, “common processes” are processes which must be carried out whether or not the program is in operation. “I/O refresh” is the process, as described above, of updating the content of the corresponding input data on the I/O memory 106 with new input data taken in from outside through the I/O interface 108 and the input/output device 4 and transmitting out the output data on the I/O memory 106 through the I/O interface 108 and the input/output device 4 to a corresponding external output terminal.

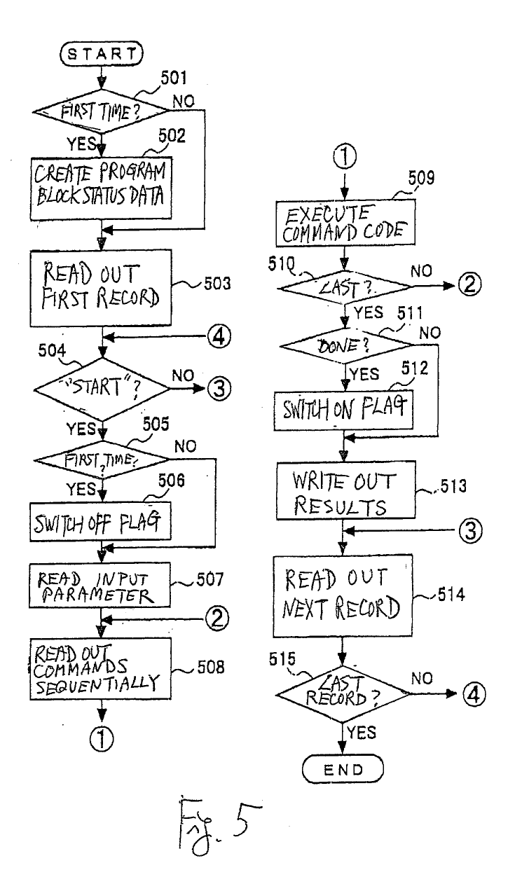

A detail of the program operation is explained next with reference to the flowchart of FIG. 5. At the beginning of the program, only at the time of the first operation (YES in Step 501), a process of newly creating “Program Block Status Data” is carried out (Step 502). In this step, as explained above, “start” is set as the status of at least some of the program blocks, as shown in FIG. 27.

Thereafter, “Program block status data” is read out sequentially (Step S514) from the first record (Step 503) to the last record (NO in Step 515). Only if “start” is set for the record which has been read out (YES in Step 504), the input parameter is read in (Step 507) and the commands in the corresponding program block are sequentially read out and executed (Steps 508 and 509). Until the last command is read out and executed (NO in Step 510), similar steps are carried out (Steps 508 and 509) for the next program block. The completion flag is switched off (Step 506) during the first time of reading out (YES in Step 505) and is switched on (Step 512) when the last command has been read out (YES in Step 510) and its execution has been completed (YES in Step 511).

The results of the execution are thereafter written out as output parameter (Step 513) and the next record of “Program block status data” is read out (Step 514). This is repeated until the last record is encountered (Yes in Step 515).

Thus, “Program block start command” and “Program block stop command” are appropriately used within a user program such that the status of each program block is set as“start” or “stop” such that the operation of each program block is started and stopped, or selectively executed, in coordination with the execution of the user program.

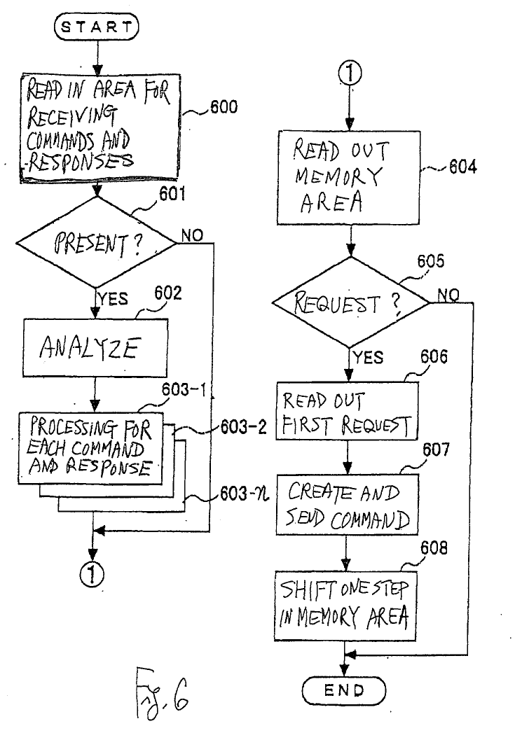

A detail of the network processing is explained next with reference to the flowchart of FIG. 6. In this processing, the following three kinds of processes are carried out, depending on the commands received from the support tool or another programmable controller as well as the requests for network processing from another process:

(1) Processing according to a command from the support tool or another programmable controller;

(2) Issuing a command according to a request for network processing from another process; and

(3) Processing according to a response to an issued command.

Commands and responses are supposed to be made by an interrupt and stored in a temporary storage area on the work memory 105.

As shown in FIG. 6, the processing starts by determining whether there is a received command or response (Steps 600 and 601). This is done by determining the presence or absence of requested network processing data in the requested network processing data storing area for receiving commands and responses. If there is a received command or response (YES in Step 601), it is analyzed (Step 602) and separate processes are carried out (Steps 603-1 to 603-n).

Processing of the five commands described above will be explained next.

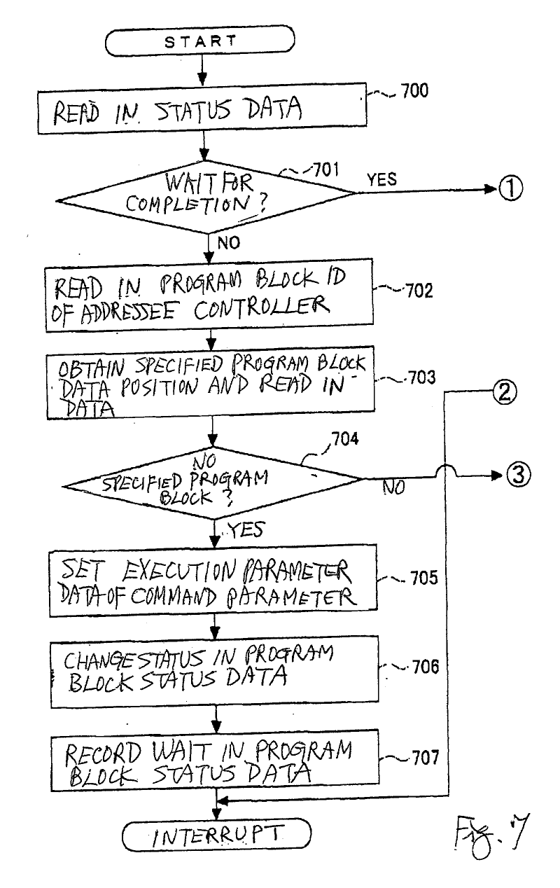

FIGS. 7 and 8 show a flowchart for the processing of “Program block starting and result obtaining command”. After this processing is started (Step 700), the program block is described as being in the wait condition for the completion of the processing. This can be ascertained by checking the “wait” record in the table of “Program block status data” shown in FIG. 27 where the “wait” record is ON in the condition of waiting for the completion of the processing and OFF in the condition of not waiting for the completion of the processing.

If it is concluded that the program block is not waiting for the completion of processing (NO in Step 701), the program block ID of the address controller of the command parameter is read in (Step 702). Next, the specified program block data position is obtained from the data position information in “Application program data” (Step 703). Next, it is examined whether there is or there is not a specified program block. If the specified program block is not present (NO in Step 704), an error response is returned to the issuer of the command (Step 807 in FIG. 8) and the processing is terminated. If the specified program block is present (YES in Step 704), “Execution parameter data” of the command parameter is set in the input parameter of the program block (Step 705). Next, the status of the corresponding program block ID is changed to “start” (Step 706) and the “wait” is recorded in “Program block status data” (of FIG. 27). The processing is then temporarily interrupted.

If it is determined in Step 701 that the program block is waiting for the completion of processing (YES in Step 701), the completion-indicating flag for the program block is checked (Step 801). Prior to Step 801, however, the program block ID of the addressee controller of the command parameter is read in (Step 800-1), specified program block data are obtained from the data area information from “Application program data” (Step 800-2) and the status of the flag indicating the completion of processing is referenced (Step 800-3). If the flag is not ON (NO in Step 801), the process is temporarily interrupted.

If the completion-indicating flag is ON (YES in Step 801), the output parameter data of the corresponding program block are read out and set as response data for the command, or the execution result data (Step 802). The flag for the corresponding program block is switched off (Step 803), the status of the corresponding program block ID is changed to “stop” (Step 804) and the “wait” is released in “Program block status data” (Step 805). Then the data are returned with a normal response (Step 806) and the process is finished. By the process explained above with reference to FIGS. 7 and 8, a specified program block is automatically started when “Program block starting and result obtaining command” is received and execution result data are returned to the origin of the command.

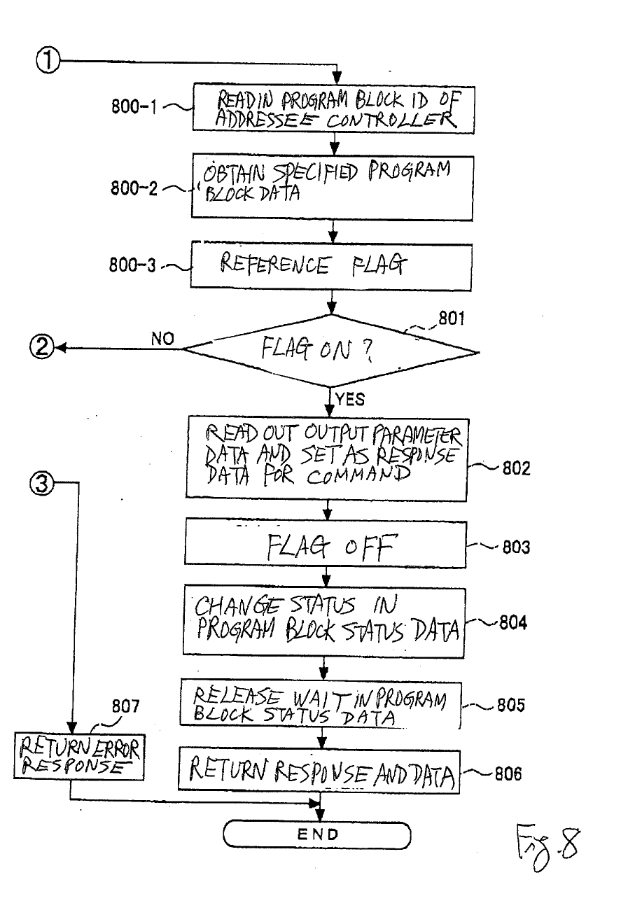

FIG. 9 shows a flowchart of the processing of “Program block starting command”. To start, the program block ID of the addressee controller in the command parameter is read in (Step 901). Next, the specified program block position is obtained from the data area information in “Application program data”, and data are read out from the obtained position (Step 902). Next, it is examined whether there is or there is not a specified program block. If there is no specified program block (NO in Step 903), an error response is returned to the issuer of the command (Step 907) and the processing is finished. If there is a specified program block (YES in Step 903), “execution parameter data” of the command parameter are set in the input parameter of the program block (Step 904). Next, the status of the corresponding program block ID is changed to “start” (Step 905). Lastly, a normal response is returned together with the data and the processing is terminated. By the process explained above with reference to FIG. 9, a specified program block is automatically started when “Program block starting command” is received and a response is returned to the issuer of the command to the effect that the program has been started.

FIG. 10 shows a flowchart of the processing of “Program block execution result obtaining command”. To start, the program block ID of the addressee controller in the command parameter is read in (Step 1001). Next, the specified program block position is obtained from the data area information in “Application program data”, and data are read out from the obtained position (Step 1002). Next, it is examined whether there is or there is not the specified program block. If the specified program block is not present (NO in Step 1003), an error response is returned to the issuer of the command (Step 1010) and the processing is terminated. If the specified program block is present (YES in Step 1003), the completion-indicating flag for the program block is referenced (Step 1004). Prior to Step 1004, however, the specified program data are obtained from the data area information from the application program and the status of the completion-indicating flag of the output parameter is referenced (Step 1003-1). If the flag for the corresponding program block is not switched on (NO in Step 1004), an incomplete execution error response is returned to the issuer of the command (Step 1009) and the processing is finished. If the flag is switched on in Step 1004, the output parameter data of the corresponding program block are read out and set as the execution result data. Next, the flag of the corresponding program block is switched off (Step 1006), and the status of the corresponding program block ID in “Program block status data” is changed to “stop” (Step 1007). Finally, a normal response is returned together with the data (Step 1008) to terminate the processing. By the process explained above with reference to FIG. 10, data corresponding to the program block execution result are returned to the issuer of the command when a program block execution result obtaining command is received.

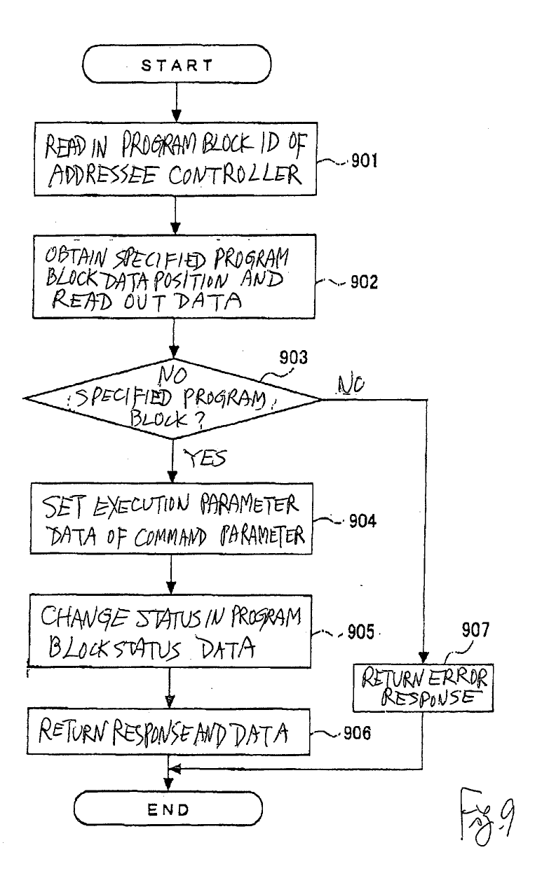

FIG. 11 shows a flowchart of the processing of “Program block writing command”. When this processing is started, the position for insertion of the program block is obtained from the data area information of “Application program data” (Step 1101). Next, it is determined whether the program block ID specified in the command parameter is already present or not. If it is already present (YES in Step 1102), an error response is returned to the issuer of the command (Step 1107) and the processing is finished. If it is determined that the program block ID specified in the command parameter is not present yet (NO in Step 1102), the program block data of the command parameter are written in at the aforementioned position for insertion as the program block ID specified in the command parameter. Next, the data area information of “Application program data” is updated (Step 1104), the program block ID which has been written in is added to “Program block status data” and the status is changed to “step” (Step 1105). Finally, a normal response is returned together with the data (Step 1106) and the processing is terminated. By the process explained above with reference to FIG. 11, the program block specified by the command parameter is automatically added to “Application program data”.

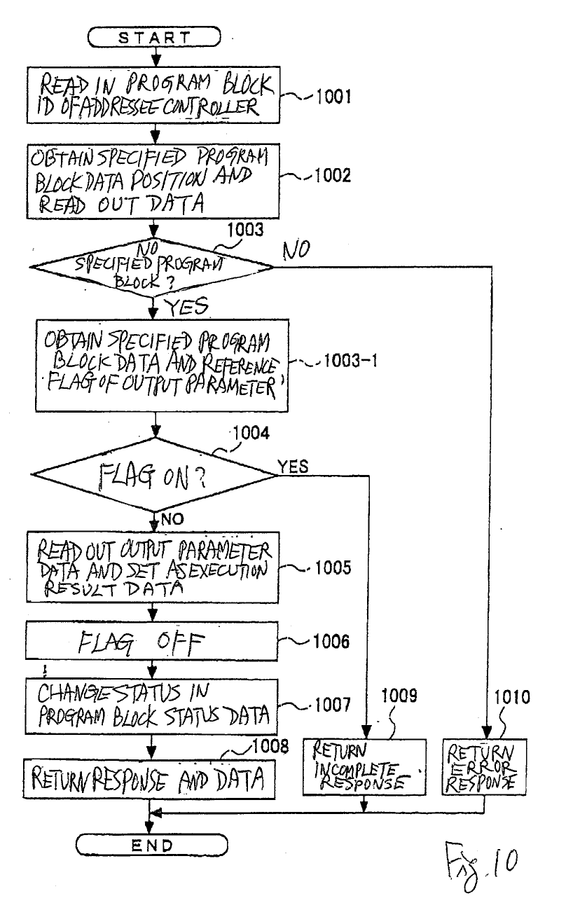

FIG. 12 shows a flowchart of the processing of “Program block deleting command”. When this processing is started, the position of the program block specified in the command parameter is obtained from the data area information of “Application program data” (Step 1201). Next, it is determined if the specified program block is present or not. If it is determined that the specified program block is not present (NO in Step 1202), an error response is returned to the issuer of the command (Step 1207) and the processing is finished. If it is determined that the specified program block is present (YES in Step 1202), this program block is deleted (Step 1203). Next, the data area information of “Application program data” is updated (Step 1204) and the record of the ID of the deleted program block is removed from “Program block status data” (Step 1205). Finally, a normal response is returned together with the data (Step 1206) and the processing is finished. By the process explained above with reference to FIG. 12, a specified program block of “Application program data” is automatically deleted when “Program block deleting command” is received.

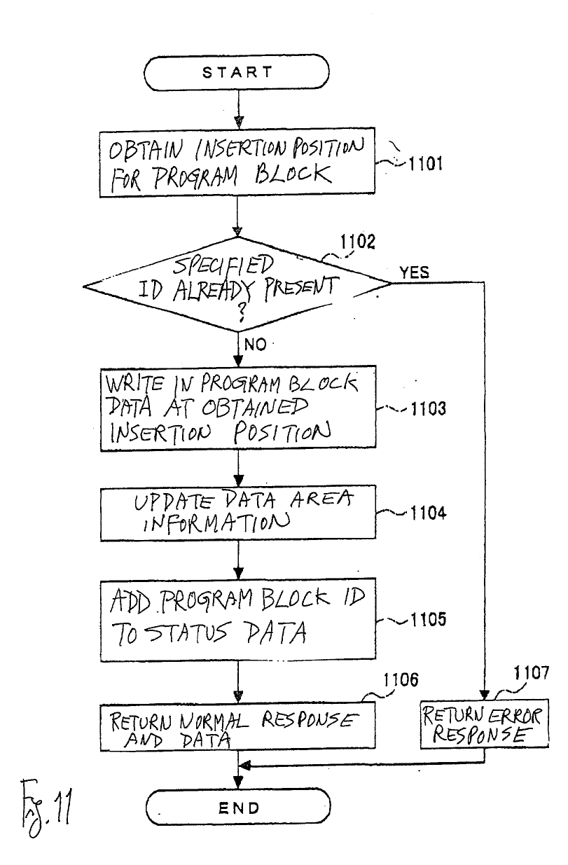

FIGS. 13 and 14 are referenced next to explain a portion of a series of operations which will be carried out when a controller (Controller A) activates a problem block on another controller (Controller B). If “Program block starting command” (RCALLPB command) is executed while Controller A is carrying out a program, data are stored in “Requested network processing data” of Controller A according to its operand data in order to carry out this command. Commands may then be issued to Controller B in the network processing by Controller A. FIGS. 13 and 14 show the processing by Controller A when such RCALLPB command is received.

At the beginning of the processing, it is determined whether a command is being issued or not. If a command is not being issued (NO in Step 1301), the network address of the controller corresponding to the controller identifier code of Operand 1 is referenced from “Network address data for controllers” (as shown in FIG. 28) (Step 1302). The determination whether a command is being issued or not may be made by providing a memory area on the work memory for each command and by referencing such memory areas.

Next, this address and the data in Operands 2 and 3 are set in the “requested network processing data storing area” (Step 1303). Next, it is determined whether or not the specified problem block is present. If it is determined that the specified program block is not present (NO in Step 1304), the processing is immediately finished. If it is determined that the specified program block is present (YES in Step 1304), “execution parameter data” of command parameter is set in the input parameter of the program block (Step 1305). Next, it is recorded on the work memory of Controller A that the command is being issued (Step 1306) and the processing is terminated.

If it is determined in Step 1301 that a command is being issued (YES in Step 1301), it is then determined if there is a response to the command or not. If it is determined that there is no response to the command (NO in Step 1401), the processing is immediately terminated. If it is determined that there is a response to the command (YES in Step 1401), it is determined whether or not this response is an error response. If it is determined that it is an error response (YES in Step 1402), the processing is terminated. If it is determined that it was not an error response (NO in Step 1402), “execution result data” from the response parameter is set at the memory address shown by Operand 4 (Step 1403). Finally, the record that a command is being issued is removed (Step 1404) and the processing is terminated. In summary, when “Program block starting command” is received, the specified program block is automatically carried out as shown by the flowchart in FIGS. 13 and 14.

With reference again to FIG. 6, if there is no received command or response (NO in Step 601), Steps 602 and 603 are skipped. Next, requested network processing data are read out of the requested network processing data storing area in the work memory 105 for transmitting commands (Step 604). As explained above, requested network processing data may be stored in the requested network processing data storing area as shown in FIG. 29. The example shown in FIG. 29 indicates that Controller A (programmable controller) is the “addressee address”, the “command” is to start a program block and to obtain results and the “parameter” includes PB 10, Data and ABCD. The second and subsequent areas are empty.

In Step 605, the content of the requested network processing data storing area as shown in FIG. 29 is referenced. If there is a request for processing (YES in Step 605), the processing of reading the first request (Step 606), the processing of creating and transmitting a command (Step 607) and the processing of shifting one step in the requested network processing data storing area (Step 608) are sequentially carried out. Thus, various commands specified by the requested network processing data are issued from this programmable controller to another programmable controller or a support tool. If it is determined that there is no request for processing (NO in Step 605), Steps 606, 607 and 608 are skipped.

Next, system programs for realizing an operating function of a support tool will be explained.

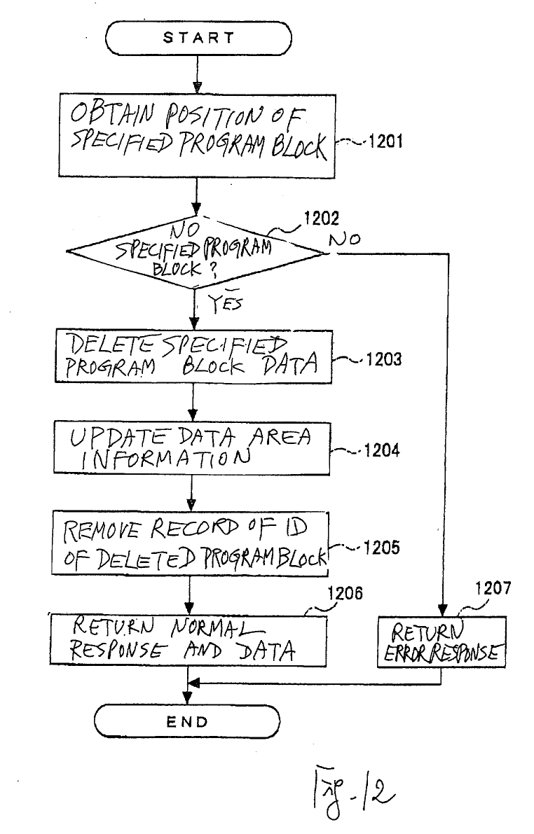

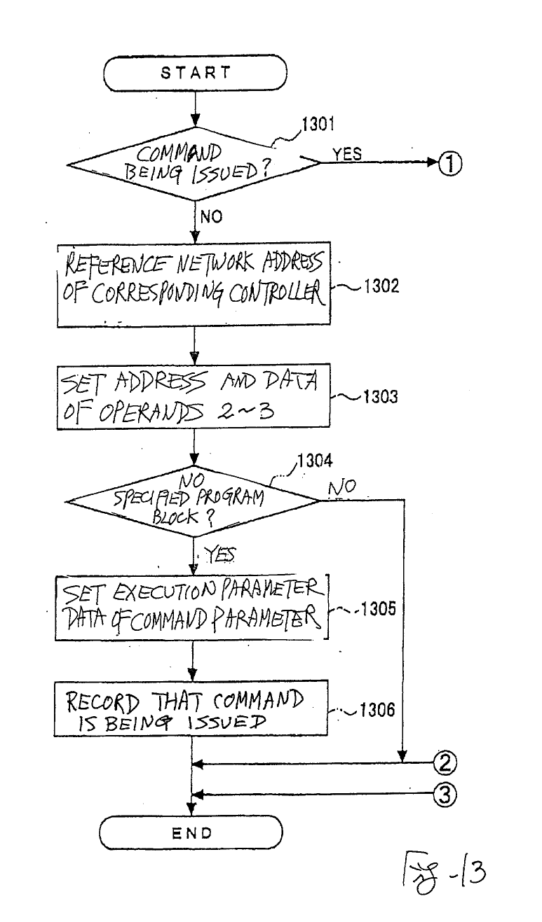

FIGS. 15 and 16 show a flowchart of a system program (as a first example) for providing the function of starting a program block from a support tool and simultaneously obtaining results of this operation.

As shown in FIG. 15, various flags and registers are initialized (Step 1501) at the beginning of the program. Next, a function selection screen is displayed (Step 1502), showing various functions as selectable branches such as the function of creating a program block and the function of starting up a program block and simultaneously obtaining results. The user selects one of the functions thus displayed on the display screen (Step 1503). If the user selects the function of creating a program block (YES in Step 1504), one of known processes for creating a program block is carried out (Step 1505) and various support functions necessary for creating a program block are provided. If the user selects the function of starting up a program block and simultaneously obtaining results (YES in Step 1601 shown in FIG. 16), one of known processes for starting up a program block and simultaneously obtaining results is carried out (Step 1602). Similarly, various other functions may be made selectable by the user. The system program is terminated with a known termination procedure (Step 1604) if the user has finished the selection of a function (YES in Step 1603).

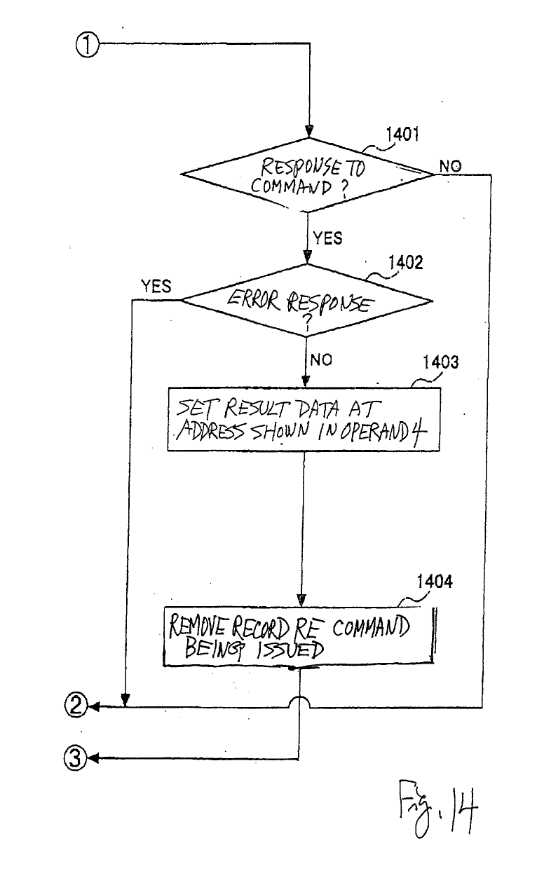

FIGS. 17 and 18 show a flowchart of a second example of system program for providing the function of starting a program block from a support tool and separately obtaining results of this operation.

As shown in FIG. 17, various flags and registers are initialized (Step 1701) at the beginning of the program. Next, a function selection screen is displayed (Step 1702) to allow the user to make a selection (Step 1703). In this example, selectable functions (as selectable branches) include that of creating a program block, that of starting up a program block and that of obtaining results of operating a program block. If the user selects the function of creating a program block (YES in Step 1704), a known process for creating a program block is carried out (Step 1705). If the user selects the function of starting up a program block (YES in Step 1706), a process as explained with reference to FIGS. 9 and 13 for starting up a program block is carried out (Step 1707). If the user selects the function of obtaining results of operating a program block (YES in Step 1801 in FIG. 18), a process as explained with reference to FIGS. 8 and 10 for obtaining results of operating a program block is carried out (Step 1802). The system program is finished with a known termination procedure (Step 1804) if the user has finished the selection of a function (YES in Step 1803).

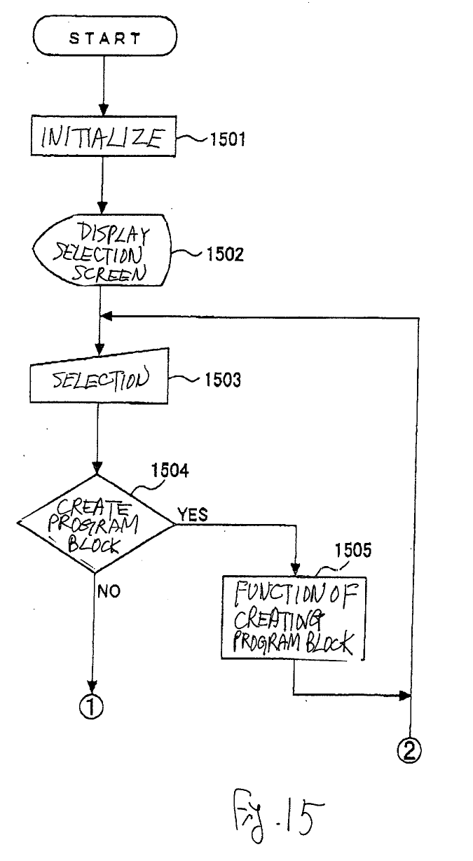

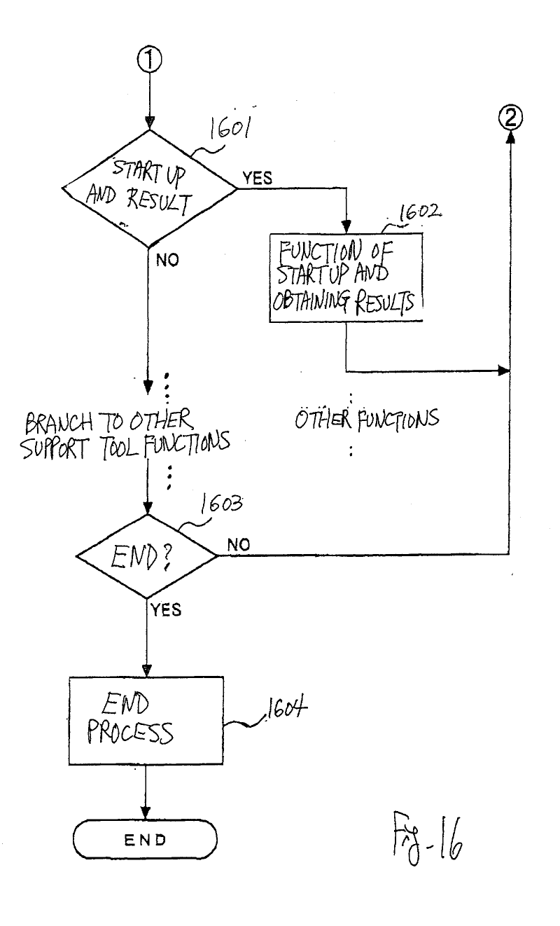

FIGS. 19 and 20 show a flowchart of a third example of system program for providing the function of adding and deleting a program block from a support tool.

As shown in FIG. 19, various flags and registers are initialized (Step 1901) at the beginning of the program. Next, a function selection screen is displayed (Step 1902) to allow the user to make a selection (Step 1903). In this example, selectable functions (as selectable branches) include that of creating a program block and that of transmitting and executing a program block. If the user selects the function of creating a program block (YES in Step 1904), a known process for creating a program block is carried out (Step 1905). If the user selects the function of transmitting and executing a program (YES in Step 2001 in FIG. 20), the function of transmitting and executing a program is carried out (Step 2002). The system program is terminated with a termination procedure (Step 2004) if the user has finished the selection of a function (YES in Step 2003).

Lastly, four examples of the user's operations using a programmable controller and a support tool will be explained.

### EXAMPLE 1

### Starting Up a Program Block From a Support Tool and Obtaining Results

A system is formed comprising a programmable controller (Controller A) and a support tool as shown in FIG. 1A. Controller A stores program blocks PB10, PB11 and PB12, partitioned as shown in FIG. 21A, as an application program. Application program data are stored in Controller A as shown in FIG. 25. Let us assume that PB10 is stopped but that PB11 and PB 12 are in operation.

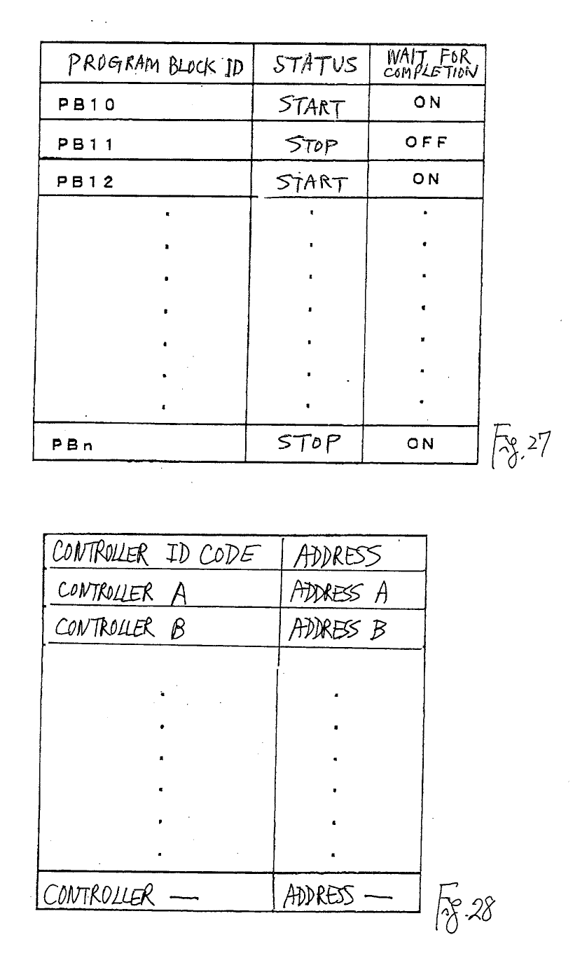

The user uses the function of the support tool for starting up a program block and obtaining results and specifies PB10. Parameters required for this purpose are inputted and a request is made, as shown in FIG. 31, to the programmable controller to carry out the process. In FIG. 31, A1 indicates a display area for a main title, A5 indicates a display area for details, numeral 3101 indicates a display area for a controller ID, numeral 3102 indicates a display area for a program block, numeral 3103 indicates a display area for an execution parameter, numeral 3104 indicates an OK selection button and numeral 3105 indicates a cancel selection button. In this situation, the support tool issues a command to Controller A through the network for starting up a program block and obtaining results (Steps 1503, 1601 and 1602).

Upon receiving this command, Controller A stores the received parameters in the input parameter and starts up PB10 (Steps 705 and 706). If PB11 is not in Controller A, an error response is transmitted (Step 807). This is carried out as a network process.

In the subsequent program operation, Controller A switches off the flag for PB 10 only during the first operation. The flag is switched on and the results are stored in the output parameter when the process is completed. A plurality of execution cycles may be required for completing a process.

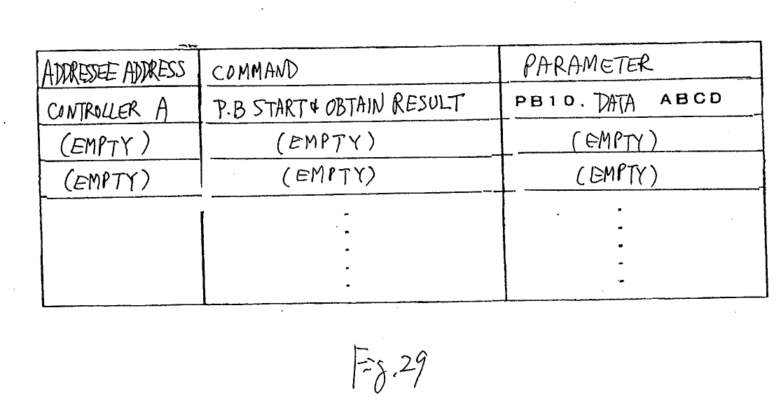

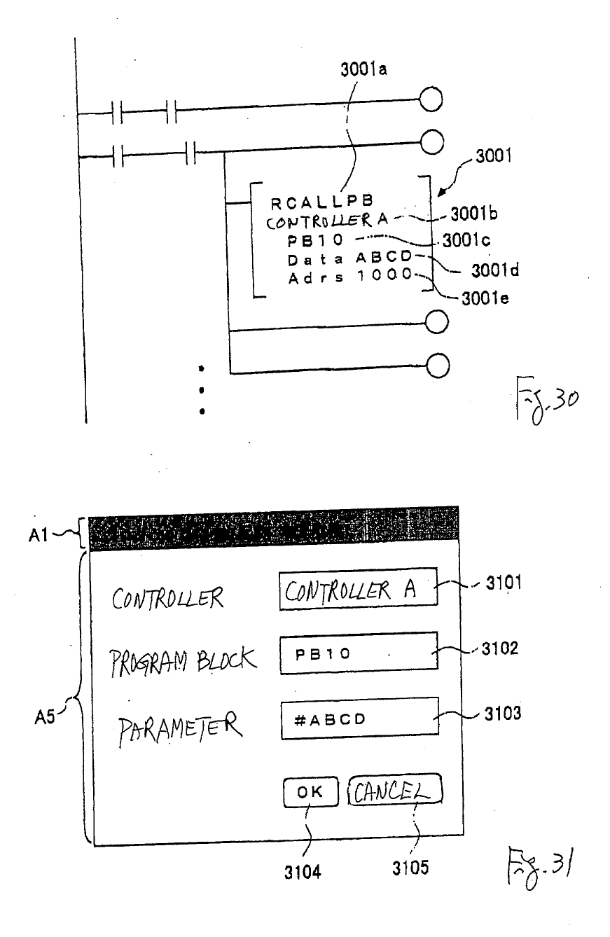

After ascertaining by network processing that the flag is on (Step 801), Controller A returns to the support tool the data which have been stored as output parameter as a response to the received command to start up a program block and to obtain result, stopping PB 10 at the same time (Steps 802, 803 and 804). Upon receiving this response from Controller A, the support tool displays the returned data as the result of the execution, as shown in FIG. 32. In FIG. 32, A1 indicates a display area for a main title, A5 indicates a display area for details and numeral 3201 indicates an OK selection button. If the response was an error response, an error display is made as shown in FIG. 33. In FIG. 33, A1 indicates a display area for a main title, A5 indicates a display area for details and numeral 3301 indicates an OK selection button.

### EXAMPLE 2

### Starting Up a Program Block From a Support Tool and Obtaining Results Separately

A system is formed comprising a programmable controller (Controller A) and a support tool as shown in FIG. 1A. Controller A stores program blocks PB10, PB11 and PB12, partitioned as shown in FIG. 21A, as an application program. Application program data are stored in Controller A as shown in FIG. 25. Let us assume that PB10 is stopped but that PB11 and PB12 are in operation.

The user uses the function of the support tool for starting up a program block and specifies PB 12. Parameters required for this purpose are inputted and a request is made, as shown in FIG. 34, to the programmable controller to carry out the process. In FIG. 34, A1 indicates a display area for a main title, A5 indicates a display area for details, numeral 3401 indicates a display area for a controller ID, numeral 3402 indicates a display area for a program block ID, numeral 3403 indicates a display area for an execution parameter, numeral 3404 indicates an OK selection button and numeral 3405 indicates a cancel selection button. In this situation, the support tool issues a command to Controller A through the network for starting up a program block (Steps 1703, 1706 and 1707).

Upon receiving this command, Controller A stores the received parameters in the input parameter and starts up PB10 (Steps 904 and 905). This is carried out as a network process and a normal termination response is returned to the support tool (Step 906) when it is finished. If PB10 is not in Controller A, an error response is transmitted (Step 907).

In the subsequent program operation, Controller A switches off the flag for PB10 only during the first operation. The flag is switched on and the results are stored in the output parameter when the process is completed. A plurality of execution cycles may be required for completing a process.

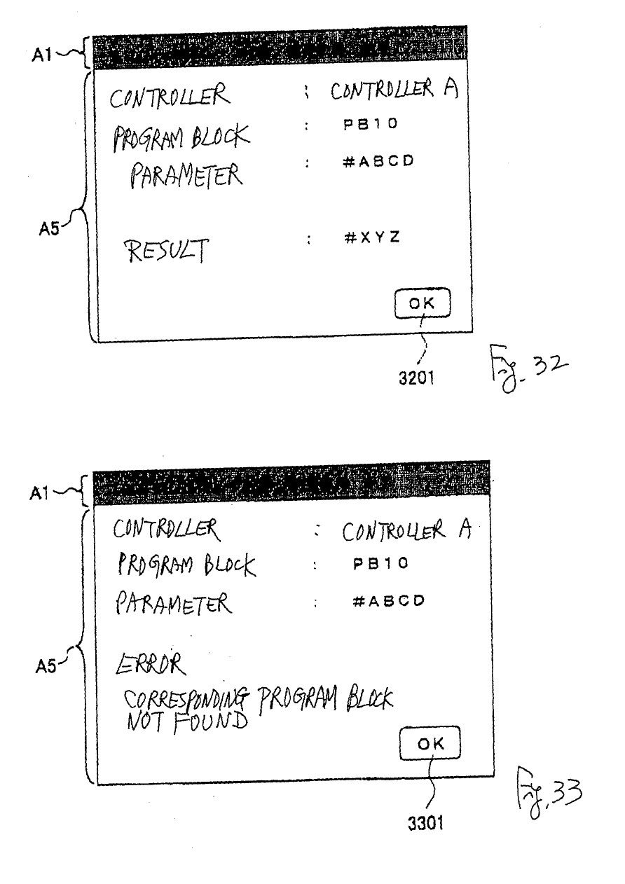

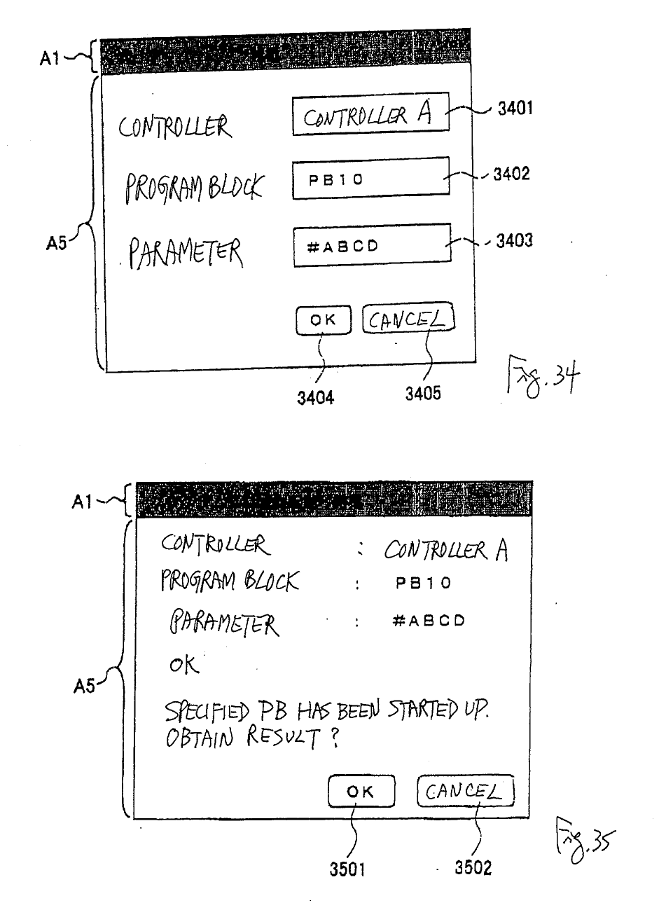

If the normal termination response is returned, indicating that PB10 has been normally started up, the support tool displays the success of the execution and asks the user whether or not the results should be obtained, as shown in FIG. 35. In FIG. 35, A1 indicates a display area for a main title, A5 indicates a display area for details, numeral 3501 indicates an OK selection button and numeral 3502 indicates a cancel selection button. The user may either proceed to obtain the results or temporarily stop the working of the tool, using separately the function of obtaining results of executing a program block. If an error response is returned, on the other hand, an error display is made on the screen as shown in FIG. 36 (Steps 1703, 1801 and 1802). In FIG. 36, A1 indicates a display area for a main title, A5 indicates a display area for details, and numeral 3601 indicates an OK selection button.

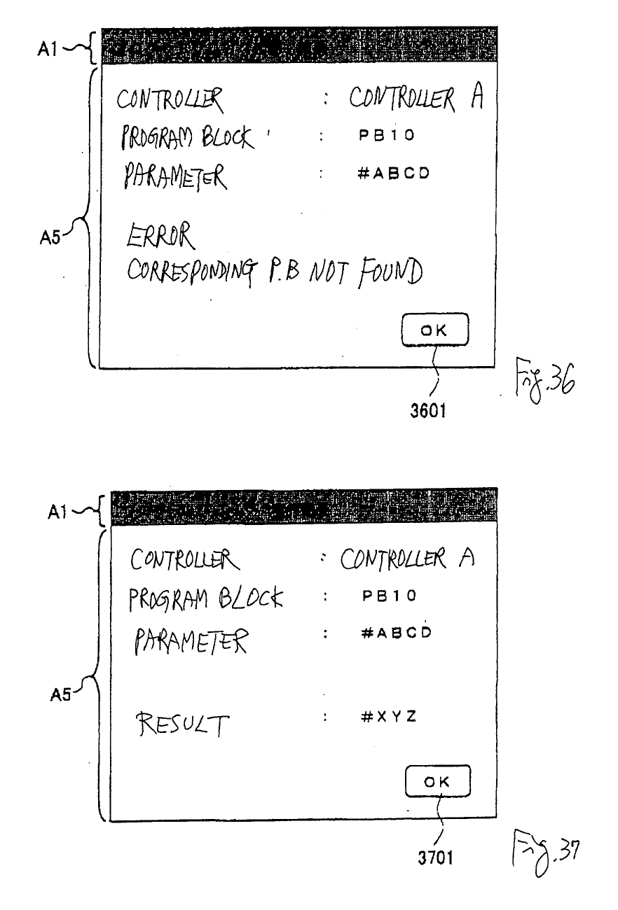

If the user inputs a command to have the results of the processing obtained, the support tool issues a command to Controller A for obtaining results of execution by a program block by indicating PB10 as parameter. Upon receiving this command, Controller A checks whether or not the flag for PB10 is on. If the flag is on, Controller A returns to the support tool the data which have been stored as output parameter as a response to the received command, stopping PB10 at the same time. If the flag is not on, an incomplete execution error response is returned as the response to the command. Upon receiving a response from Controller A, the support tool displays the returned result, as shown in FIG. 37. In FIG. 37, A1 indicates a display area for a main title, A5 indicates a display area for details and numeral 3701 indicates an OK selection button. If the response was an error response, an error display is made and another execution is suggested, as shown in FIG. 38. In FIG. 38, A1 indicates a display area for a main title, A5 indicates a display area for details, numeral 3801 indicates an OK selection button and numeral 3802 indicates a cancel selection button.

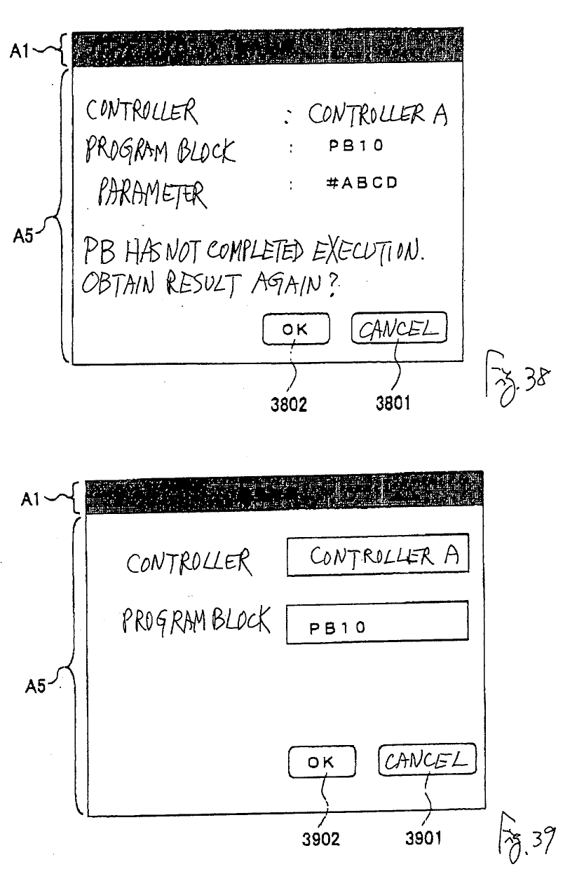

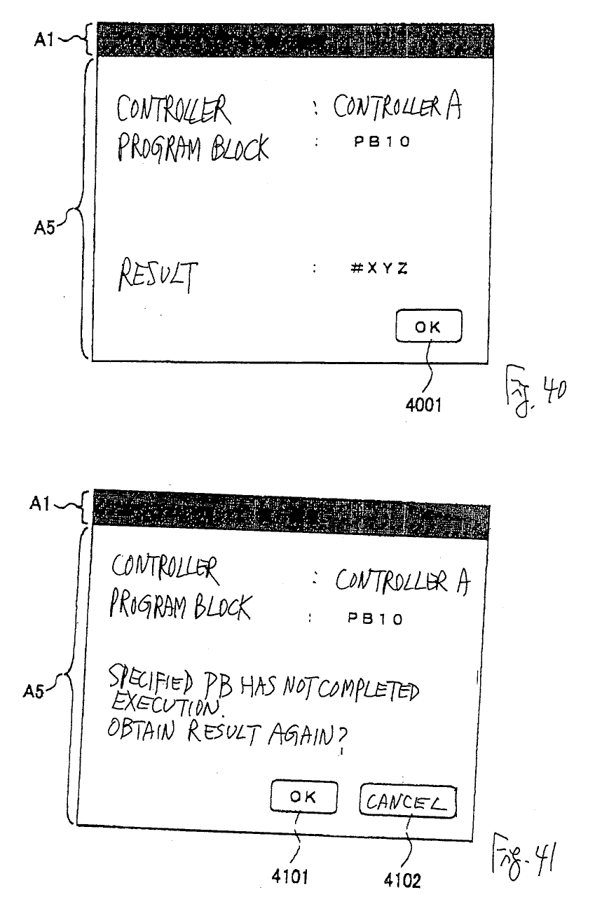

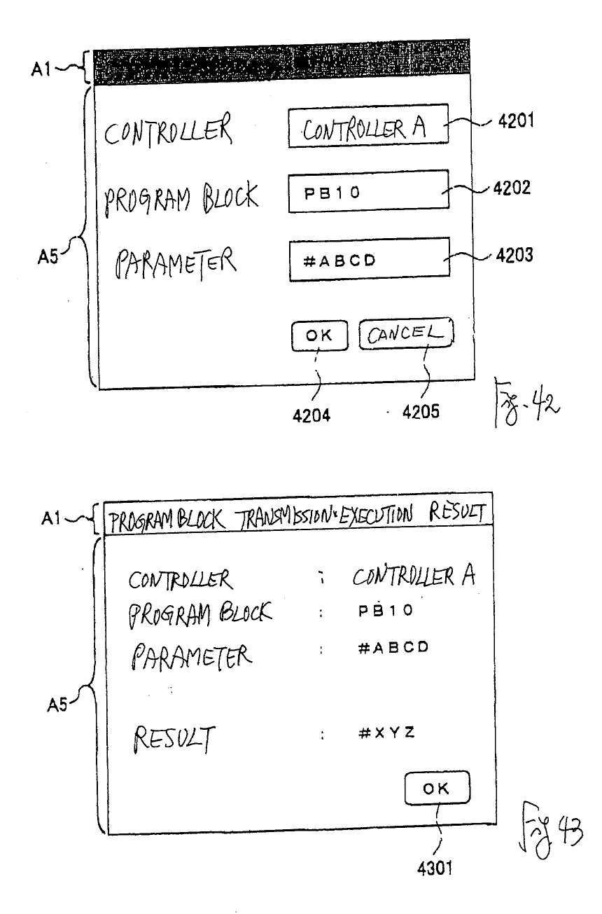

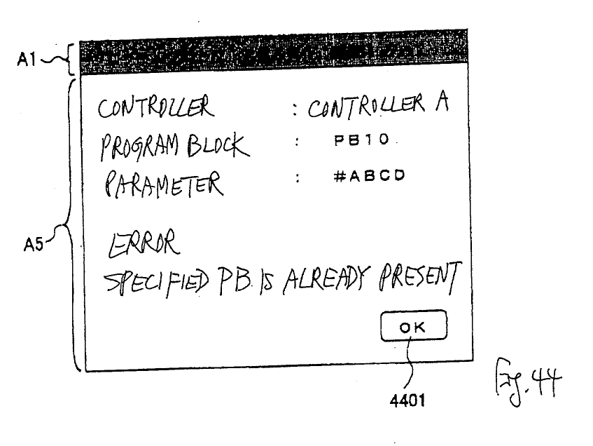

If the user decides to stop the operation after a program block has been started up and to later obtain the results of executing the program block, the program block is specified again, as shown in FIG. 39. In FIG. 39, A1 indicates a display area for a main title, A5 indicates a display area for details, numeral 3901 indicates an OK selection button and numeral 3902 indicates a cancel selection button. The support tool issues a command to Controller A for obtaining results of execution by a program block by indicating PB10 as parameter (Steps 1703, 1801 and 1802). Upon receiving this command, Controller A checks whether or not the flag for PB10 is on. If the flag is on, Controller A returns to the support tool the data which have been stored as output parameter as a response to the received command, stopping PB10 at the same time (Steps 1005, 1006 and 1007). If the flag is not on, an incomplete execution error response is returned as the response to the command (Step 1009). Upon receiving a response from Controller A, the support tool displays the returned result, as shown in FIG. 40. In FIG. 40, A1 indicates a display area for a main title, A5 indicates a display area for details and numeral 4001 indicates an OK selection button. If the response was an error response, an error display is made and another execution is suggested, as shown in FIG. 41. In FIG. 41, A1 indicates a display area for a main title, A5 indicates a display area for details, numeral 4101 indicates an OK selection button and numeral 4102 indicates a cancel selection button.

### EXAMPLE 3

### Adding and Deleting a Program Block From a Support Tool

A system is formed comprising a programmable controller (Controller A) and a support tool as shown in FIG. 1A. Controller A stores program blocks PB10, PB11 and PB12, partitioned as shown in FIG. 21A, as an application program. Application program data are stored in Controller A as shown in FIG. 25.

The user makes use of the support tool to preliminarily prepare program block data for PB20. The function of transmitting and executing a program block is used to specify PB20 and after parameters are inputted, the execution is requested of Controller A (Steps 1903, 2001 and 2002). First, the support tool transmits through the network the program block data of PB20 to Controller A by a “write in program block” command. Upon receiving this command, Controller A stores the program block data of PB20 at a specified position (Steps 1103, 1104 and 1105). As a result, the content of application program data is now as shown in FIG. 26, and the structure of the application program is as shown in FIG. 21B. This is carried out as a network process.

Upon receiving a normal response from Controller A, the support tool issues a command for starting a program block and obtaining results together with execution parameter data by specifying PB20. Upon receiving this command, Controller A stores the parameter received with the command in the input parameter and starts up PB20. This is carried out as a network process.

In the subsequent program operation, Controller A switches off the flag for PB20 only during the first operation. The flag is switched on and the results are stored in the output parameter when the process is completed. A plurality of execution cycles may be required for completing a process.

After ascertaining by network processing that the flag for PB20 is on, Controller A returns to the support tool the data which have been stored as output parameter as a response to the received command to start up a program block and to obtain result, stopping PB20 at the same time. Upon receiving this response from Controller A, the support tool displays the returned data as the result of the execution of the command for transmission and execution of a program block and issues a command to Controller A to delete the program data of PB20. Upon receiving this command, Controller A deletes the data of PB20 from the application program. As a result, the application program goes back to the condition shown in FIG. 25 and the structure of the application program now looks as shown in FIG. 21A.

### EXAMPLE 4

### Starting Up a Program From Another Programmable Controller and Obtaining Results Simultaneously

A system is formed comprising two programmable controllers (Controllers A and B), as shown in FIG. 1B. Controller A stores partitioned program blocks as shown in FIG. 21A as an application program. Application program data are stored in Controller A as shown in FIG. 25. Let us assume that PB10 is stopped but that PB11 and PB12 are in operation. As shown in FIG. 30, Controller B stores a program block containing “Program block starting command” (shown at 3001) for starting up program blocks of Controller A. The identifier code for Controller A is programmed in Operand 1 (3001b) of “Program block start command code” (3001a). The identifier code for PB10 which is a program block stored in Controller A is programmed in Operand 2 (3001c). Parameter data for executing PB10 are programmed in Operand 3 (3000d). The memory address on the programmable controller for storing results of execution is programmed in Operand 4.

If aforementioned “Program block starting command” is executed in the execution of the program blocks of Controller B, Controller B extracts necessary information from the operands. Information in Operand 1 is converted to a network address by referencing “Network address data for controllers” shown in FIG. 28 and stored as shown in FIG. 29 in the requested network processing data storing area together with information in Operands 2 and 3. It is recorded that a command is being executed, and the commands for that cycle are executed.

In a network processing by Controller B, “Program block starting and result obtaining command” is issued to Controller A through the network on the basis of the information in the requested network processing data storing area. Upon receiving this command, Controller A stores the parameters received with the command in the input parameter and starts up PB10. This is carried out by network processing.

In the subsequent program operation, Controller A switches off the flag for PB10 only during the first operation. The flag is switched on and the results are stored in the output parameter when the process is completed. A plurality of execution cycles may be required for completing a process.

After ascertaining by network processing that the flag is on, Controller A returns to the support tool the data which have been stored as output parameter as a response to the received command to start up a program block and to obtain result, stopping PB10 at the same time. Upon receiving a response from Controller A in network processing, Controller B stores the response data as result of execution.

After “Program block starting command” is executed by Controller B, if a command is being issued, it is checked whether a response has been received from Controller A. If no response has been returned, it proceeds to execute a next command. If a response has been received, the response data are copied at the memory address shown in Operand 4 and the record that a command is being issued is removed, Thus, the application program of Controller B can reference the results of execution of PB10 of Controller A to use them in other processes.

In Example 3, transmission of program block data and starting up of a program block may be treated as separate functions. In Example 4, separate commands may be used for starting up a program block and obtaining results of execution, as done in Example 2.

Merits of the present invention include the following:

(1) Since sampling of data necessary for a process is carried out by a programmable controller for executing program blocks, frequent sampling of data through the network is not necessary and only the result of execution can be received. Thus, the burden on the network becomes lighter.

(2) Since sampling of data necessary for a process is carried out by a programmable controller for executing program blocks, data can be sampled quickly independent of the time required for the transmission of data through the network.

(3) When a request for operation is received from outside, the method of request is concentrated on execution parameters and data are not read out or written in according to addresses specified from outside. Thus, programs do not have to be corrected or modified when data assignment is changed.

(4) When the program for a programmable controller is already partitioned, if it is desired to distribute it among a plurality of programmable controllers, this can be done simply by adding a program logic for taking out those of the program blocks to be distributed, storing them in other programmable controllers and starting them up from outside.

(5) New program blocks can be added to a program in operation and can be operated to obtain results. The added program blocks can be deleted after the result of operation is obtained. Necessary functions can be added only when they are needed. Thus, the burden on the resources of programmable controllers can be reduced. Remote operations on a programmable controller becomes possible, for example, for maintenance and trouble shooting in the case of an unexpected trouble.

What is claimed is:

1. A programmable controller system comprising:
a plurality of programmable controllers including a first controller and a second controller, each of said plurality of programmable controllers storing one or more program blocks and executing said program blocks selectively and individually by switching between an active condition and a stopped condition; and
communication means through which said programmable controllers transmit and receive data among said programmable controllers;
said first controller having command issuing means for issuing a command to carry out a specified operation on a specified program block of said second controller;
said second controller having operating means for carrying out said specified operation in response to said command received from said first controller.

2. The programmable controller system of claim 1 wherein said command causes said specified program block to be started up and executed by setting execution parameter data of command parameter of said command in input parameter of said specified program block and output parameter data of said specified program block to be read out and returned as result of execution of said specified program block to the issuer of said command.

3. The programmable controller system of claim 1 wherein said command causes said specified program block to be started up and executed by setting execution parameter data of command parameter of said command in input parameter of said specified program block

4. The programmable controller system of claim 1 wherein said command causes output parameter data of said specified program block to be read out and returned as result of execution of said specified program block to the issuer of said command.

5. The programmable controller system of claim 1 wherein said command is accompanied by a program block and causes said accompanying program block to be written in a program block storing area.

6. The programmable controller system of claim 1 wherein said command causes said specified program block to be deleted.

7. A programmable controller system comprising:
a programmable controller storing one or more program blocks and executing said program blocks selectively and individually by switching between an active condition and a stopped condition;
communication means; and
one or more other devices exchanging data through said communication means with said programmable controller;
wherein at least one of said other devices includes command issuing means for issuing a command to carry out a specified operation on a specified program block of said programmable controller; and
wherein said programmable controller includes means for carrying out said specified operation in response to said command received from said at least one of said other devices.

8. A programmable controller storing one or more program blocks, said programmable controller comprising:
executing means for executing said program blocks selectively and individually by switching between an active condition and a stopped condition;
communicating means for exchanging data with another device through communication means connected to said programmable controller; and
responding means for receiving a command from said another device through said communicating means and carrying out an operation according to said command.
